(19) United States
(12) Patent Application Publication
(10) Pub. No.: US 2006/0091662 A1
(43) Pub. Date: May 4, 2006

(54) Airbag and airbag apparatus

(75) Inventors: Kei Tsujimoto, Hikone-shi (JP); Wataru Nakazawa, Higashioumi-shi (JP); Yoshitaka Matsui, Kanzaki-gun (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/248,236

(22) Filed: Oct. 13, 2005

(30) Foreign Application Priority Data
Oct. 28, 2004 (JP) 2004-314187

(51) Int. Cl. B60R 21/16

(52) U.S. Cl. 280/743.1; 280/730.2

(57) ABSTRACT

An airbag has two base cloths with a high airtightness at sewn portions, and an airbag apparatus including the airbag and an inflator. The airbag is formed by sewing the two base cloths together with a sewing thread such that chambers are provided between the base cloths. A gas injection hole is provided at an end of the airbag. Each base cloth includes a main body made of a woven cloth and a coating layer made of thermoplastic resin formed on one side of the main body. When the base cloths are sewn together, one of the base cloths is placed on the other in such a manner that the coating layers of the base cloths come into contact with each other, and then the base cloths are adhered to each other by heating the portions to be sewn and applying pressure to the base cloths as necessary.

### BACKGROUND OF THE INVENTION AND RELATED ART STATEMENT

The present invention relates to an airbag apparatus mounted in an automobile or the like and an airbag included in the airbag apparatus.

A typical airbag apparatus mounted in a vehicle, such as an automobile, includes an airbag and an inflator for inflating the airbag. When, for example, the vehicle collides, gas is discharged from the inflator and the airbag is inflated by the gas.

Typically, the airbag is formed by sewing two base cloths together such that an inflatable chamber is provided between the base cloths.

In order to increase the airtightness between the sewn portions of the base cloths, the sewn portions are often sealed by applying a sealant made of silicon resin or the like to the base cloths. However, the manufacturing efficiency of the air bag is low since it takes a long time for the sealant to dry.

Japanese Unexamined Patent Application Publication No. 8-301036 discloses an airbag including two circular base cloths constructed of thermofusible woven cloths of nylon, polyester, or the like. The base cloths are heat-sealed to each other at the outer periphery thereof, and are then sewn together at the inner periphery of the heat-sealed portions thereof.

In the airbag according to Japanese Unexamined Patent Application Publication No. 8-301036, the base cloths are sewn at the inner periphery of the heat-sealed portions of the base cloth, and the sewn portions are not heat-sealed. Therefore, when the pressure in the airbag is increased, the sewn portions open and the airtightness between the sewn portions is reduced.

An object of the present invention is to provide an airbag having a high airtightness at sewn portions and an airbag apparatus including the airbag.

Further objects and advantages of the invention will be apparent from the following description of the invention.

### SUMMARY OF THE INVENTION

In order to attain the objects described above, an airbag according to a first aspect of the present invention includes two base cloths that are sewn together such that an inflatable chamber is provided between the base cloths. At least one of the base cloths has a coating layer made of thermoplastic resin at least at the sewn portion thereof, and the sewn portions of the base cloths are adhered to each other by heat-sealing the coating layer.

According to another aspect, the sewn portions are adhered to each other by heat-sealing the coating layer and main bodies of the base cloths.

In addition, an airbag apparatus according to the present invention includes the airbag structure as described above and an inflator.

In the airbag according to the present invention, the sewn portions of the base cloths are adhered to each other by heat-sealing the coating layer. Therefore, the sewn portions are prevented from opening, and the airtightness between the sewn portions is high.

Although the sewn portions of the base cloths may be adhered to each other by heat-sealing only the coating layer, the main bodies of the base cloths may also be adhered by heat-sealing together with the coating layer. In this case, the overall bodies of the base cloths are adhered to each other by heat-sealing at the sewn portions thereof, and therefore the airtightness and strength of the airbag at the sewn portions are further increased.

### BRIEF DESCRIPTION OF THE DRAWINGS

FIG. 1 is a front view of an airbag according to an embodiment;

FIG. 2 is a sectional view of FIG. 1 taken along line II-II; and

FIG. 3 is a sectional view of a base cloth.

### DETAILED DESCRIPTION OF PREFERRED EMBODIMENTS

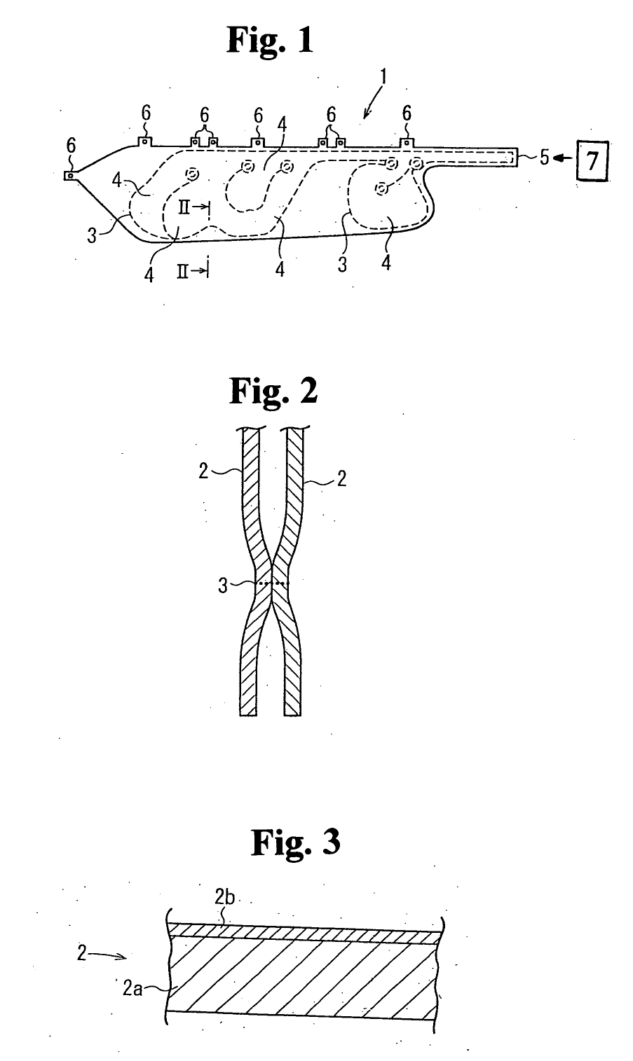

An embodiment will be described below with reference to the drawings. FIG. 1 is a front view of an airbag according to the embodiment, FIG. 2 is a sectional view of FIG. 1 taken along line II-II, and FIG. 3 is a sectional view of a base cloth.

An airbag 1 is a curtain airbag disposed near a roof side rail of an automobile, and deploys downward along the inner sides of a door and a pillar of the automobile when the airbag 1 inflates.

The airbag 1 is formed by sewing two base cloths 2 together with a sewing thread 3 such that chambers 4 are provided between the base cloths 2. A gas injection hole 5 is provided at an end of the airbag 1, and an inflator 7 is connected to the gas injection hole 5 to form an airbag apparatus. The airbag 1 has projecting tabs 6 for attaching the airbag 1 to the roof side rail and an A pillar. The airbag 1 is folded into a long, thin shape, and is disposed so as to extend along the roof side rail. When gas is discharged from the inflator, the airbag 1 deploys downward along the door and the pillar as described above.

As shown in FIG. 3, each base cloth 2 includes a main body 2a made of a woven cloth and a coating layer 2b made of thermoplastic resin formed on one side of the main body 2a. When the base cloths 2 are sewn together, one of the base cloths 2 is placed on the other in such a manner that the coating layers 2b of the base cloths 2 come into contact with each other, and then the base cloths 2 are adhered to each other by heating the portions to be sewn and by applying pressure to the base cloths as necessary. Next, the base cloths 2 are sewn together at the portions to be sewn with the sewing thread 3. The base cloths 2 may also be sewn together with the sewing thread 3 before the coating layers 2b thereof are adhered to each other by heat-sealing.

In the airbag 1 structured as above, the sewn portions of the base cloths 2 are adhered to each other by heat-sealing the coating layers 2b, and therefore the airbag 1 has high airtightness. In addition, a time required for heat-sealing is short, and therefore the airbag 1 can be manufactured with high efficiency.

Although the airbag 1 is a curtain airbag in the above-described embodiment, the present invention may also be applied to other kinds of airbags, such as a passenger airbag, a driver airbag, and a side airbag.

In addition, although the coating layer extends over the entire area of each base cloth in the above-described embodiment, the coating layer may also be provided only at the portion to be sewn.

In addition, although each of the base cloths 2 includes the coating layer 2b in the above-described embodiment, the coating layer 2b may be provided in only one of the base cloths 2.

In addition, although the main bodies 2a are not heat-sealed in the above-described embodiment, the main bodies 2a may also be made of thermoplastic cloth material and be heat-sealed together with the coating layers 2b. In this case, the overall bodies of the base cloths are adhered to each other by heat-sealing at the sewn portions thereof, and therefore the airtightness and strength of the airbag at the sewn portions are further increased.

The disclosure of Japanese Patent Application No. 2004-314187 filed on Oct. 28, 2004 is incorporated herein.

While the invention has been described with reference to specific embodiments of the invention, the explanation is illustrative and the invention is limited only by the appended claims.

What is claimed is:

1. An airbag, comprising:
two base cloths connected together at respective sewn portions such that an inflatable chamber is provided between the base cloths;
wherein at least one of the base cloths has a coating layer made of thermoplastic resin at least at the sewn portion thereof; and the sewn portions of the base cloths are adhered to each other by heat-sealing the coating layer.

2. The airbag according to claim 1, wherein the sewn portions are adhered to each other by heat-sealing the coating layer and main bodies of the base cloths.

3. The airbag according to claim 2, wherein the main bodies of the base cloths comprise a thermoplastic material.

4. The airbag according to claim 1, wherein both of the base cloths have the coating layer at least at the sewn portion thereof.

5. The airbag according to claim 4, wherein at least one of the base cloths has the coating layer extending over substantially the entire area of the base cloth.

6. The airbag according to claim 5, wherein both of the base cloths have the coating layer extending over substantially the entire area of the respective base cloth.

7. The airbag according to claim 1, further comprising a thread sewingly connecting the two base cloths at the sewn portion.

8. The airbag according to claim 1, further comprising at least one projecting tab for securing the airbag to a structure.

9. The airbag according to claim 1, further comprising a gas injection hole defined by at least one of the two base cloths, the gas injection hole forming an opening to the inflatable chamber.

10. An airbag apparatus comprising the airbag according to claim 1 and an inflator.
